(19) United States
(12) Patent Application Publication
(10) Pub. No.: US 2010/0307408 A1
(43) Pub. Date: Dec. 9, 2010

(54) COATING DEVICE

(75) Inventors: Naoki Kishimoto, Tochigi (JP); Masaaki Shoji, Tochigi (JP); Daisuke Saito, Tochigi (JP); Yuichi Ito, Tochigi (JP); Mitsuya Murata, Tochigi (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd., Minato-ku, Tokyo (JP)

(21) Appl. No.: 12/867,192

(22) PCT Filed: Feb. 16, 2009
(86) PCT No.: PCT/JP2009/052517

§ 371 Date: Aug. 11, 2010

(30) Foreign Application Priority Data
Feb. 18, 2008 (JP) 2008-035805

(51) Int. Cl. B05C 5/00; B05B 7/00

(52) U.S. Cl. 118/300

(57) ABSTRACT

Provided is a coating device which can spray, while mixing uniformly, a plurality of kinds of base materials and a curing agent. The coating device comprises a supply pipe (12) for delivering the base materials and curing agent, and a rotary atomization head rotating about a line passing through the distal end face of the supply pipe (12) and atomizing and spraying the base materials and curing agent delivered from the supply pipe (12). The rotary atomization head comprises a spreading portion spreading toward the spraying direction while surrounding the distal end face of the supply pipe (12), and a substantially disc-shaped closing portion facing the distal end face of the supply pipe (12) and closing the inner wall surface of the spreading portion. A circumferential through hole is formed in the closing portion so as to penetrate from the front surface to the back surface, and two base material outlets (121A, 122A) for delivering two kinds of base materials, respectively, and a plurality of curing agent outlets (123A) arranged annularly so as to surround the two outlets are formed in the distal end face of the supply pipe (12).

### TECHNICAL FIELD

The present invention relates to a coating device. Specifically, it relates to a coating device that electrostatically coats works.

### BACKGROUND ART

Conventionally, a three-coat three-bake method has been known as a method for coating the body of an automobile. Three-coat three-bake is a method in which treatment is performed in a sequence of electrostatic coating, drying, intermediate coating, drying, base coating, clear coating, and drying.

Herein, for the coating color of the intermediate coating, there are three colors of black, grey, and white depending on the color (brightness) of a vehicle. More specifically, in the intermediate coating, paint of each color is discharged from a nozzle of a coating device, and atomized to be sprayed by a rotary atomization head.

Incidentally, in recent years, a three-coat two-bake method has been proposed as a coating method. This is a method in which a treatment by a drying oven is not performed after the intermediate coating has been performed. In other words, intermediate coating is performed with two liquids, i.e. a curing agent (isocyanate) mixed with a base material of paint, and base coating is performed after preliminary heating.

In this case, for example, the base material of paint and the curing agent are discharged simultaneously from nozzles of the coating device, and atomized while the base material and the curing agent are mixed by the rotary atomization head (refer to Japanese Unexamined Patent Application Publication No. 2000-126654).

### DISCLOSURE OF THE INVENTION

### Problems to be Solved by the Invention

However, these paint and curing agent are supplied to the coating device from paint tanks of each color through pipes (circulation). As described above, in the three-coat two-bake method, since the curing agent is used in addition to the paint compared to the three-coat three-bake method, there have been problems in that the number of pipes becomes great, and thus a large pipe space becomes necessary.

In addition, when changing paint colors, there has been a problem in that a loss of paint occurs and the amount of paint used becomes large.

In order to solve these problems, it has been considered to reduce the types of paints as raw materials by mixing the black color and the white color to make grey colors; however, when attempting to make a grey color, it is necessary to discharge the black color, the white color and the curing agent from the nozzles simultaneously, and thus the development of a method for atomizing the black paint, white paint and curing agent while mixing them uniformly has been demanded.

The present invention has an object of providing a coating device that can atomize base materials of a plurality of types and a curing agent while mixing them uniformly.

### Means for Solving the Problems

A coating device (e.g., coating device 1 described later) comprising: a supply pipe (e.g., supply pipe 12 described later) that discharges a base material and a curing agent; and a rotary atomization head (e.g., atomization head 20 described later) that atomizes to spray the base material and the curing agent discharged from the supply pipe while rotating about a straight line (e.g., straight line R described later) through a distal end surface of the supply pipe as an axis of rotation, wherein the rotary atomization head includes an expansion portion (e.g., expansion portion 21 described later) that surrounds the distal end surface of the supply pipe and expands in a spray direction, and a blocking portion (e.g., blocking portion 22 described later) of a substantially disk shape that faces the distal end surface of the supply pipe and blocks an inner wall surface of the expansion portion, wherein a through-hole (e.g., rim-portion through hole 222 described later) is formed in the blocking portion, the through-hole penetrating front and back surfaces thereof, and wherein a plurality of base material outlets (e.g., base material outlets 121A, 122A described later) and a plurality of curing agent outlets (e.g., curing agent outlets 123A described later) are formed in the distal end surface of the supply pipe, a plurality of types of base materials being respectively discharged from the plurality of base material outlets and the plurality of curing agent outlets being disposed to surround the plurality of base material outlets in a ring shape and discharging the curing agent.

According to the present invention, when a curing agent and a plurality of types of base materials are discharged from the distal end surface of the supply pipe in a state in which the rotary atomization head is made to rotate, these base materials and the curing agent reach a surface of the blocking portion, which faces the distal end surface of the supply pipe. These base materials and the curing agent flow to an outer circumferential side of the blocking portion while being mixed by way of the rotation of the blocking portion, then pass through the through-holes and reach the expansion portion. Thereafter, they are atomized and sprayed by way of the rotation of the expansion portion.

Herein, since the curing agent outlets are disposed on an outer side of the base material outlets, the area where the curing agent and the base material contact with each other can be increased compared to a case in which the curing agent outlets are disposed on an inner side of the base material outlets, and accordingly the curing agent and the base material can be mixed evenly. Therefore, the plurality of types of base materials and the curing agent can be sprayed while being made to mix uniformly.

### EFFECTS OF THE INVENTION

According to the present invention, when the curing agent and the plurality of types of base materials are discharged from the distal end surface of the supply pipe in a state in which the rotary atomization head is made to rotate, these base materials and the curing agent reach the surface of the blocking portion facing the distal end surface of the supply pipe. These base materials and curing agent flow to the outer circumferential side of this blocking portion while being mixed by way of the rotation of the blocking portion, and reach the expansion portion through the through-hole. Thereafter, they are atomized and sprayed by way of the rotation of the expansion portion. Herein, since the curing agent outlet is disposed on the outer side of the base material outlet, the area where the curing agent and base material contact can be increased compared to a case of disposing the curing agent outlet on the inner side of the base material, and thus the curing agent and base material can be mixed evenly. Therefore, the plurality of types of base materials and the curing agent can be atomized while causing them to be mixed uniformly.

### BRIEF DESCRIPTION OF THE DRAWINGS

FIG. 1 is a view showing a schematic diagram of a coating device according to an embodiment of the present invention;

FIG. 2 is a cross-sectional view of a distal end portion of the coating device according to the embodiment;

FIG. 3 is a front view of a supply pipe of the coating device according to the embodiment;

FIG. 4 is a cross-sectional view along the line A-A of FIG. 3;

FIG. 5 is a cross-sectional view along the line B-B of FIG. 3;

FIG. 6 is a graph showing a relationship between the degree of mixing of the paint mixture of white paint and black paint, and a V value of this paint mixture;

FIGS. 7A and 7B are a front view and a side cross-sectional view of a supply pipe, respectively, according to an Example; and

FIG. 8 is a graph showing a relationship between deviation of the V value of the paint mixture and the velocity of a bell edge.

### EXPLANATION OF REFERENCE NUMERALS

1 Coating device
12 Supply pipe
20 Rotary atomization head
21 Expansion portion
22 Blocking portion
121A Base material outlet
122A Base material outlet
123A Curing agent outlet
222 Rim-portion through-hole
R Straight line

### PREFERRED MODE FOR CARRYING OUT THE INVENTION

Hereinafter, embodiments of the present invention will be explained based on the drawings.

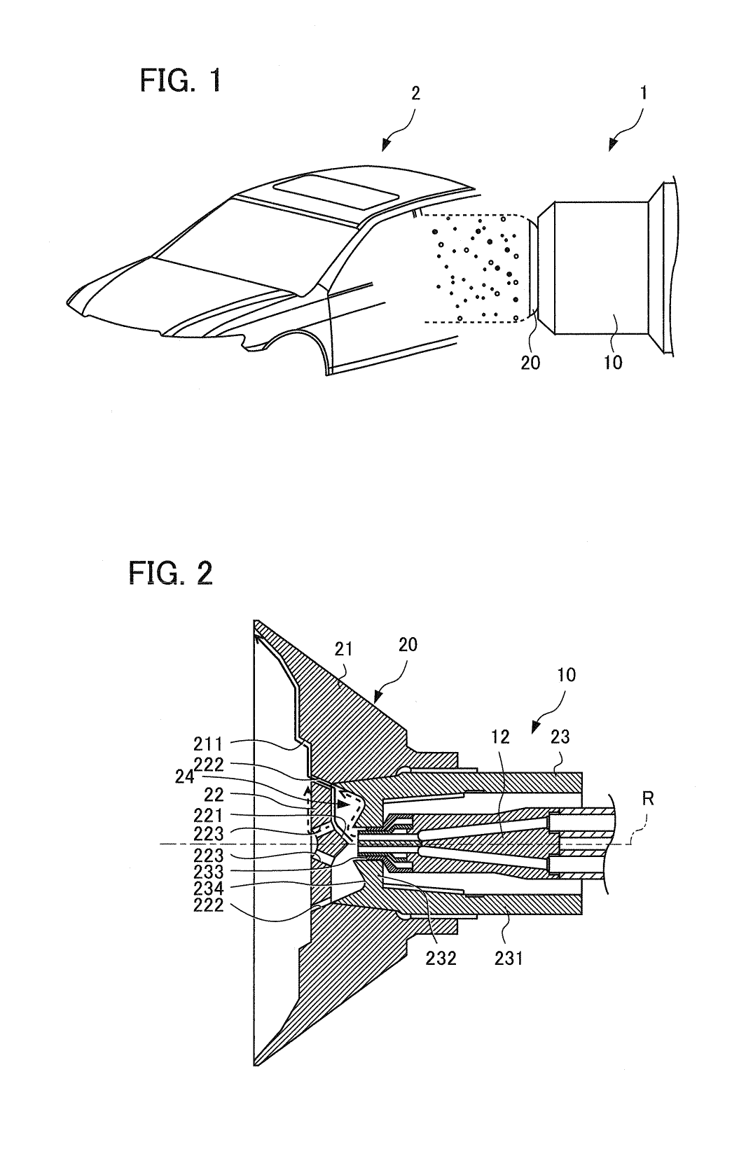

FIG. 1 is a view showing a schematic diagram of a coating device 1 of the present invention.

The coating device 1 electrostatically sprays atomized paint onto a body 2 of an automobile, which is an object to be coated, and includes a main body 10 and a rotary atomization head 20 rotatably provided to this main body 10.

FIG. 2 is a cross-sectional view of a distal end portion of the coating device 1.

The main body 10 is a cylindrical shape, and includes a supply pipe 12 that supplies paint and solvent to the rotary atomization head 20, a motor not shown that causes the rotary atomization head 20 to rotate by way of air pressurized and fed from a compressor, and a high-voltage generator not shown that causes the paint to be electrified.

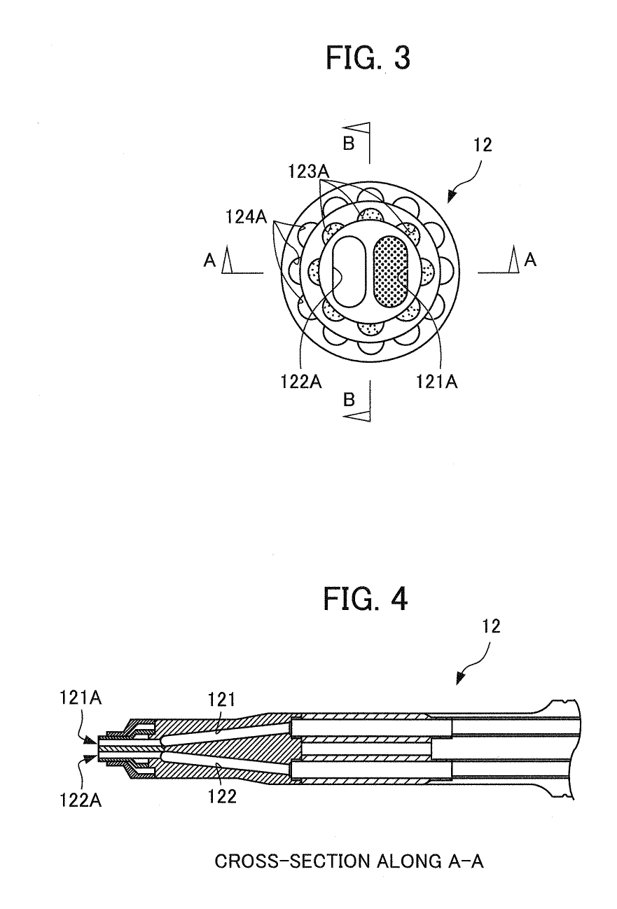

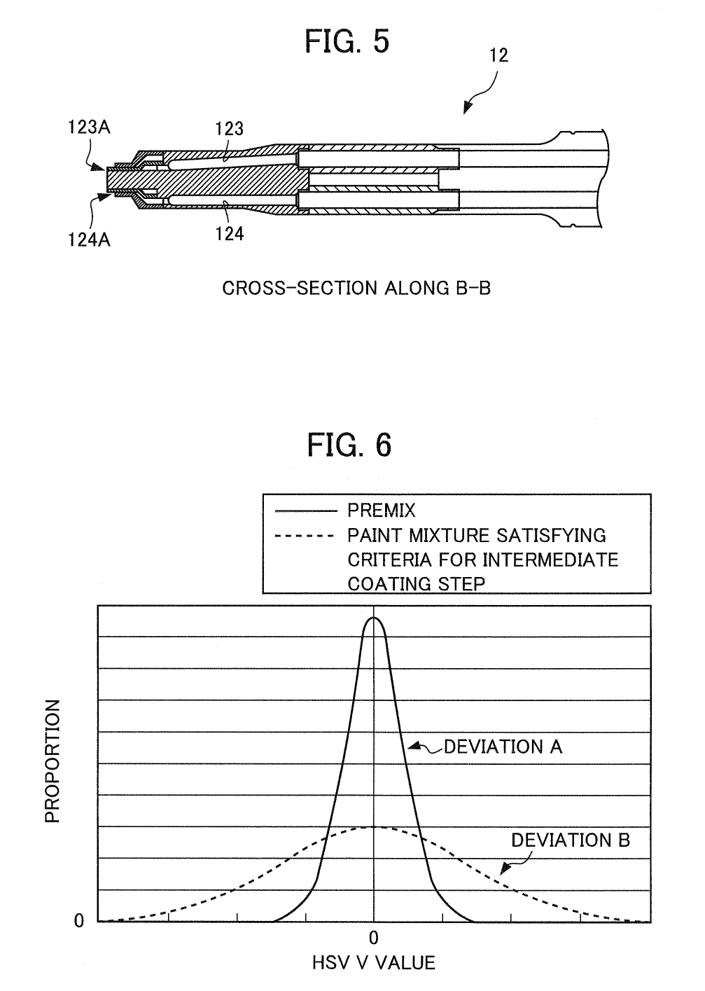

FIG. 3 is a front view of the supply pipe 12. FIG. 4 is a cross-sectional view along the line A-A of FIG. 3, and FIG. 5 is a cross-sectional view along the line B-B of FIG. 3.

The supply pipe 12 discharges two types of paint as base materials, curing agent, and solvent. This supply pipe 12 is formed by paint-flow paths 121 and 122 through which the two types of paint flow, a curing agent-flow path 123 through which the curing agent flows, and a solvent-flow path 124 through which a solvent for washing paint adhered to the rotary atomization head 20 flows.

At the distal end surface of the supply pipe 12 are formed: two base material outlets 121A and 122A at which the two types of paint are respectively discharged; a plurality of curing agent outlets 123A that is disposed to surround the two outlets 121A and 122A in a ring shape and discharges the curing agent; and a plurality of solvent outlets 124A that is disposed to surround the curing agent outlets 123A in a ring shape and discharges the solvent.

This supply pipe 12 is opened and closed by way of a needle valve not shown moving forward and backward, whereby causing the supply of the paint, curing agent and solvent to the rotary atomization head 20 to be performed and stopped.

Referring again to FIG. 2, the rotary atomization head 20 rotates about a rotational axis of a straight line R through the distal end surface of the supply pipe 12, causing the base material, curing agent, and solvent discharged from the supply pipe 12 to be atomized and sprayed.

The rotary atomization head 20 includes a rotation portion 23 of a cylindrical shape in which the supply pipe 12 is accommodated inside, an expansion portion 21 that surrounds the distal end surface of the supply pipe 12 provided at a distal end of this rotation portion 23 and expands in a spray direction, and a blocking portion 22 of a substantially disk shape that faces the distal end surface of the supply pipe 12 and blocks an inner wall surface of the expansion portion 21.

The rotation portion 23 includes a rotation-portion main body 231 of a cylindrical shape, and a distal end portion 232 of a substantially disk shape that blocks a distal end of this rotation-portion main body 231. The expansion portion 21 is mounted by threads to this rotation portion 23.

A through-hole 233 is formed substantially at the center of the distal end portion 232.

The supply pipe 12 is inserted to the rotation portion 23, and the distal end of the supply pipe 12 is exposed from the through-hole 233 of the distal end portion 232. In addition, the circumference of the through-hole 233 of the distal end portion 232 is concaved, and thus this concaved portion serves as a paint collection portion 234 at which paint collects.

A space that is blocked by the inner wall surface of the expansion portion 21 and the blocking portion 22 serves as an atomization compartment 24 for imparting centrifugal force to the paint. On a more distal end side of the inner wall surface of the expansion portion 21 than the blocking portion 22, a step 211 is formed.

A projection 221 of a substantially cone shape is formed at a position facing the supply pipe 12 in a surface on an inner side of the blocking portion 22 (surface on a side of the atomization compartment 24).

In addition, a plurality of rim-portion through-holes 222 that penetrates front and back surfaces along the inner wall surface of the expansion portion 21 is formed in a rim portion of the blocking portion 22, thereby allowing the inside and outside of the atomization compartment 24 to communicate with each other.

In addition, a plurality of central through-holes 223 that penetrates the front and back surfaces is formed in a central portion of the blocking portion 22.

Hereinafter, behavior of the coating device 1 during coating operation will be explained while referring to FIG. 2.

Paint and a curing agent are discharged to the atomization compartment 24 while the rotary atomization head 20 is made to rotate. Consequently, almost all of the paint and curing agent thus discharged reach and collide with the projection 221 of the blocking portion 22, as shown by the solid line of FIG. 2. Since the rotary atomization head 20 is rotating at a high speed, centrifugal force acts on the paint colliding with the projection 221, and the paint and curing agent move along the surface of the inner side of the blocking portion 22 toward the rim portion of the blocking portion 22, while being mixed by way of the rotation of the rotary atomization head 20.

The paint and the curing agent that have reached the rim portion of the blocking portion 22 pass through the rim-portion through-holes 222 and move to outside of the atomization compartment 24, and further move along the inner wall surface of the expansion portion 21 toward an outer edge of the distal end of the expansion portion 21. During this movement, the paint and the curing agent are further mixed by way of the step 211.

With approaching the outer edge portion of the expansion portion 21, the centrifugal force acting on the paint and the curing agent develops greater, causing the paint and the curing agent to break up into a large number of minute drops to be in form of spray. The paint of this spray scatters from the outer edge portion of the expansion portion 21, and adheres to the surface of the object to be coated.

Next, behavior of the coating device 1 during cleaning operation will be explained while referring to FIG. 2.

This cleaning operation is performed in a case of changing the paint used in the coating device 1 to a different type of paint, or in a case of ending the coating operation.

A solvent is discharged from the paint supply pipe to the atomization compartment 24 while the rotary atomization head 20 is made to rotate. Herein, the number of revolution of the rotary atomization head during the cleaning operation is set to be less than the number of revolution during the coating operation.

Since the number of revolution of the rotary atomization head 20 is less than the number of revolution during the coating operation, a portion of the solvent thus discharged passes through the paint collection portion 234 formed at the circumference of the distal end portion 232 and is directed towards the rim-portion through-holes 222, as shown by the dotted line in FIG. 2.

In addition, similarly to during the coating operation, after the solvent thus discharged has reached and collided with the projection 221 of the blocking portion 22, it moves towards the rim portion of the blocking portion 22. Thereafter, the solvent passes through the rim-portion through-holes 222, and moves along the inner wall surface of the expansion portion 21 towards the outer edge portion of the expansion portion 21.

In addition, a portion of the solvent that has reached the projection 221 of the blocking portion 22 passes through the central through-holes 223 and reaches a surface on an outer side of the blocking portion 22, and then moves along the surface on the outer side of the blocking portion 22 due to centrifugal force towards the outer edge portion of the blocking portion 22.

### Example and Comparative Example

Electrostatic spraying was performed by the coating devices of an Example and a Comparative Example, which were each supplied with white paint, black paint and curing agent, and the degree of mixing of the paints was judged.

FIG. 6 is a graph showing a relationship between the degree of mixing of the paint mixture of white paint and black paint, and a V value of this paint mixture.

More specifically, the following process was performed for a paint mixture with a degree of mixing satisfying the criteria in the intermediate coating step, and a mixture of black paint and white paint mixed in advance (i.e. premix).

The paint mixture mixing white paint and black paint was coated on a test piece by way of a coating device. Then, the coated surface of this test piece was photographed, and V values (brightness) in HSV color space were plotted. In addition, an average value of the V values was calculated, and the deviation of the V values was obtained based on this average value.

Consequently, a correlation was recognized between the degree of mixing and the deviation of the V values. It was understood that the more the degree of mixing increases and the paint mixture homogenized, the width of the peak becomes narrower while the peak of the V value becomes higher. Therefore, it is determined that the smaller the deviation of the V values, the higher the degree of mixing becomes.

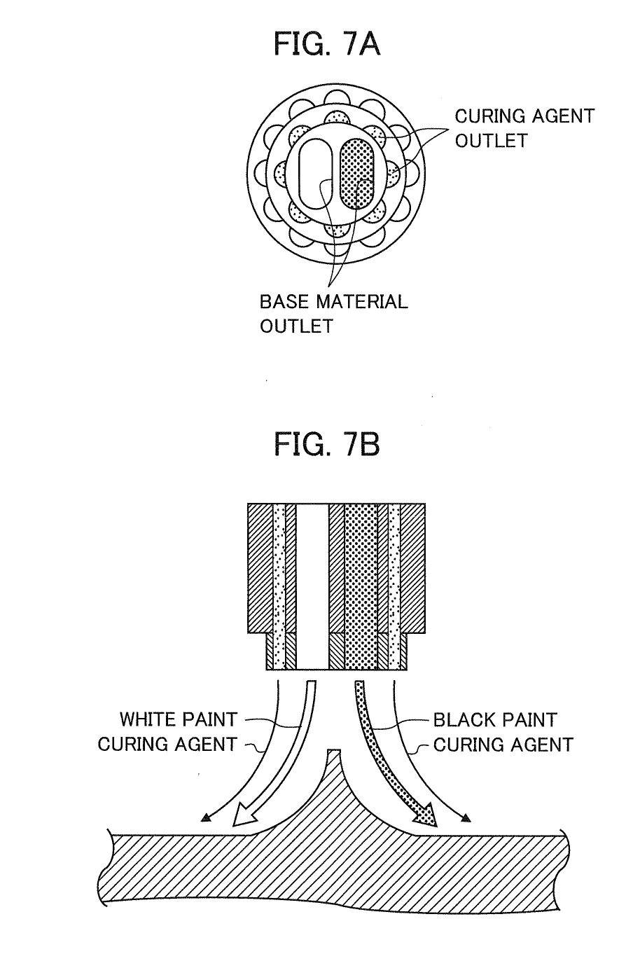

FIGS. 7A and 7B are a front view and a side cross-sectional view, respectively, of the supply pipe of the coating device according to the Example.

In the Example, base material outlets were provided at a center of a distal end surface of a supply pipe, and a white paint and a black paint were made to discharge from these base material outlets. In addition, a plurality of curing agent outlets was provided to surround these base material outlets in a ring shape, and the curing agent was made to discharge from these curing agent outlets.

On the other hand, in the Comparative Example, a curing agent outlet was provided at a center of a distal end surface of a supply pipe, and a curing agent was made to discharge from this curing agent outlet. In addition, base material outlets were provided to surround this curing agent outlet in a ring shape, and a white paint and a black paint were made to discharge from these base material outlets.

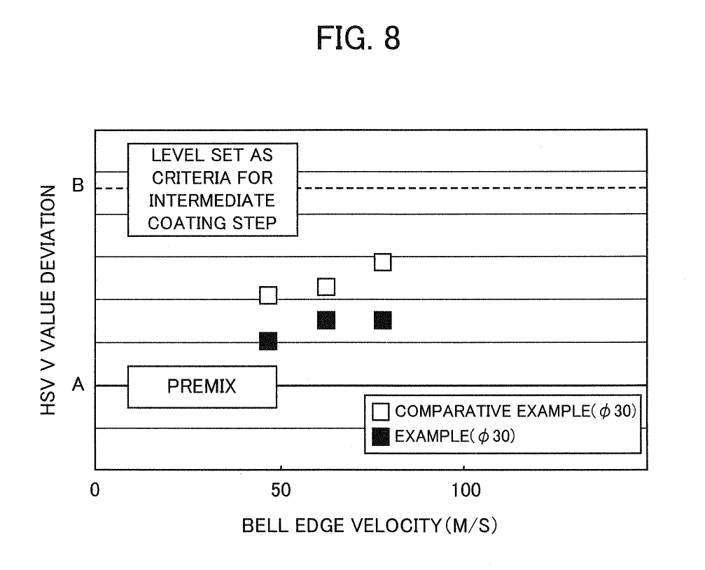

FIG. 8 is a graph showing a relationship between the deviation of the V values of the paint mixture and the velocity of the bell edge.

For each coating device of the Example and the Comparative Example, a test piece was coated using a bell having a diameter of 30 mm. Then, the coated surface of this test piece was photographed. The average value of the V values (brightness) in HSV color space was calculated. The deviation of the V values was obtained based on this average value, and then plotted.

In a case of the diameter of a bell being large, since the distance of the inner wall surface of the bell cup becomes long, mixing of the paint and the curing agent on this inner wall surface is promoted. Accordingly, the deviation of the V values approaches a level close to that of the premix, irrespective of the shape of the supply pipe of the coating device.

On the other hand, in a case of the diameter of a bell being as small as 30 mm, although the deviation of the V values did not approach a level close to that of the premix for the coating device of the Comparative Example, the deviation of the V values approached a level closer to that of the premix for the coating device of the Example. In other words, the degree of mixing of paint performed by the coating device according to the Comparative Example resulted in a lower value; on the other hand, the degree of mixing of paint performed by the coating device according to the Example resulted in a higher value.

Therefore, it is understood that, even in a case of the diameter of the bell being small and the distance of the bell inner wall surface being short, two types of base materials and a curing agent can be uniformly mixed by adopting the configuration of the coating device according to the Example.

According to the present embodiment, the following effects can be achieved.

(1) When a curing agent and two types of base materials are discharged from the distal end surface of the supply pipe 12 while the rotary atomization head 20 is made to rotate, the base materials and the curing agent reach the surface of the blocking portion 22, which faces the distal end surface of the supply pipe 12. The base materials and the curing agent flow to an outer circumferential side of this blocking portion 22 while being mixed by the rotation of the blocking portion 22, then pass through the rim-portion through holes 222, and reach the expansion portion 21. Thereafter, they are atomized and sprayed by the rotation of the expansion portion 21. Herein, since the curing agent outlets 123A are disposed on an outer side of the base material outlets 121A and 122B, the area where the curing agent and base material contact with each other can be increased compared to a case in which the curing agent outlets are disposed on an inner side of the base material outlet, and accordingly the curing agent and base material can be mixed evenly. Therefore, two types of base materials and a curing agent can be sprayed while being made to mix uniformly.

It should be noted that the present invention is not to be limited to the embodiment described above, and modifications, improvements and the like within a scope that can achieve the object of the present invention are included in the present invention.

1. A coating device comprising:
a supply pipe that discharges a base material and a curing agent; and
a rotary atomization head that atomizes to spray the base material and the curing agent discharged from the supply pipe while rotating about a straight line through a distal end surface of the supply pipe as an axis of rotation,
wherein the rotary atomization head includes an expansion portion that surrounds the distal end surface of the supply pipe and expands in a spray direction, and a blocking portion of a substantially disk shape that faces the distal end surface of the supply pipe and blocks an inner wall surface of the expansion portion,
wherein a through-hole is formed in the blocking portion, the through-hole penetrating front and back surfaces thereof, and
wherein a plurality of base material outlets and a plurality of curing agent outlets are formed in the distal end surface of the supply pipe, a plurality of types of base materials being respectively discharged from the plurality of base material outlets and the plurality of curing agent outlets being disposed to surround the plurality of base material outlets in a ring shape and discharging the curing agent.
